(19) United States
(12) Patent Application Publication
(10) Pub. No.: US 2024/0227564 A1
(43) Pub. Date: Jul. 11, 2024

(54) POWER SUPPLY SERVICE SYSTEM

(71) Applicant: TOYOTA JIDOSHA KABUSHIKI KAISHA, Toyota-shi (JP)

(72) Inventor: Hiroshi OKIGA, Toyota-shi (JP)

(73) Assignee: TOYOTA JIDOSHA KABUSHIKI KAISHA, Toyota-shi (JP)

(21) Appl. No.: 18/511,076

(22) Filed: Nov. 16, 2023

(30) Foreign Application Priority Data
Jan. 10, 2023 (JP) 2023-001837

(51) Int. Cl. B60L 1/00; B60R 16/023

(52) U.S. Cl. CPC B60L 1/006; B60R 16/0231

(57) ABSTRACT

The power supply controller and the navigation device control whether or not power is supplied from the battery to USB port and AC port, and transmit the present position of battery electric vehicle to the outside of the vehicle. The server computer is capable of communicating with the power supply controllers and storing available parking positions of battery electric vehicle. Then, the server computer transmits, to the power supply controller, the power supply permission information that permits the supply of power when the current position received from the power supply controller matches the available parking position, and transmits, to the power supply controller, the power supply prohibition information that prohibits the supply of power when the current position and the parking possible position do not match.

### CROSS-REFERENCE TO RELATED APPLICATION

This application claims priority to Japanese Patent Application No. 2023-001837 filed on Jan. 10, 2023, incorporated herein by reference in its entirety.

### BACKGROUND

### 1. Technical Field

The technology disclosed in the present specification relates to a power supply service system that uses a power supply port included in a vehicle.

### 2. Description of Related Art

Japanese Unexamined Patent Application Publication No. 2020-79993 (JP 2020-79993 A), a technique is disclosed in which when the shift range is a parking range, shifting to a control mode called a “my room” mode by performing a predetermined operation is performed. In the “my room” mode, the operation of the auxiliary equipment is permitted while the vehicle is prohibited from traveling. This makes it possible for a user in the vehicle cabin to take a rest while operating an air conditioner, to listen to music by operating an audio device, or to connect an electric device carried in to an in-vehicle outlet and use the device. In other words, in the “my room” mode, it is possible to literally provide the user with the vehicle cabin as a relaxing space similar to his or her own room.

### SUMMARY

Meanwhile, in recent years, a service in which a vehicle cabin space of a battery electric vehicle is made available as a private room or a small office and is lent out has been studied. Although car sharing as moving means is further advanced and the use form is studied in which the vehicle cabin space is utilized as a living room or a work space in the same manner as the “my room” mode of the vehicle of JP 2020-79993 A, it is possible for the user to move freely when he or she drives the vehicle. Therefore, there is a possibility that the user erroneously parks the vehicle in a place where parking for a long time is not permitted, and uses the vehicle as a “my room” for long hours. The present specification provides a technique for avoiding inconvenience due to a parking place when a vehicle is provided as a living room or a working space.

A power supply service system disclosed in the present specification uses a power supply port included in a vehicle, and includes: a power supply mounted on the vehicle; an in-vehicle computer; and an outside computer. The in-vehicle computer controls whether to supply power from the power supply to the power supply port, and transmits a current position of the vehicle to an outside of the vehicle. The outside computer is able to communicate information with the in-vehicle computer, and stores an available parking position of the vehicle. The outside computer transmits power supply permission information for allowing supply of the power to the in-vehicle computer when the current position of the vehicle coincides with the available parking position, and transmits power supply prohibition information for prohibiting supply of the power to the in-vehicle computer when the current position does not coincide with the available parking position.

Accordingly, in order to receive power supplied from the power supply port, the vehicle must be parked at a predetermined available parking position. In locations where parking is not possible, no power is supplied from the power supply port, making it difficult to park the vehicle in such locations. Therefore, the above-described inconvenience due to a parking place can be avoided. In addition, power cannot be supplied when the vehicle moves from a predetermined available parking position. Therefore, also a traveling vehicle cannot be supplied with power, so that it is possible to prompt a user to concentrate on driving in the traveling vehicle.

Further, the power supply service system disclosed in the present specification may further include an information terminal device. The information terminal device is able to communicate information with the outside computer and transmits a desired parking position of the vehicle. The outside computer stores also a candidate parking area in which parking of the vehicle is available. When the desired parking position received from the information terminal device is included in the candidate parking area, the outside computer stores the desired parking position as the available parking position. Accordingly, the outside computer adds, in addition to the already stored available parking position of the vehicle, for example, the desired parking position of the vehicle transmitted from the information terminal device operated by the user of the vehicle to the available parking position. Therefore, even when the vehicle is parked at the desired parking position, power can be supplied from the power supply port. Therefore, it is possible to increase the available parking position in accordance with the needs of the user.

Further, when the desired parking position received from the information terminal device is not included in the candidate parking area, the outside computer may select a candidate parking position closest to the desired parking position from within the candidate parking area, and transmit the selected candidate parking position to the information terminal device. Thus, for example, the user of the vehicle who operates the information terminal device can know the nearest candidate parking position when the previously transmitted desired parking position is not available. The user can save the trouble of searching for a nearby available parking position stored in the outside computer. Therefore, the convenience of the user can be improved.

Further, the outside computer may transmit the power supply prohibition information to the in-vehicle computer after a predetermined time has elapsed since transmission of the power supply permission information. Accordingly, when a predetermined time elapses after power supply from the power supply port of the vehicle is started, the power supply is stopped, so that it is possible to suppress such a power supply service from being used without limit in time. Further, it is possible to provide the power supply service as a time-based service.

Details of the technology disclosed in the present specification and further improvements are described in the embodiments of the disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a configuration example of a power supply service system according to an embodiment;

FIG. 2 is a flowchart illustrating a basic type of power supply availability control processing executed by an outside computer constituting the power supply service system according to the embodiment;

FIG. 3 is a flowchart illustrating a candidate position addition type of the power supply availability control process executed by the outside computer constituting the power supply service system of the embodiment;

FIG. 4 is a flowchart illustrating a candidate position proposal type of the power supply availability control process executed by the outside computer constituting the power supply service system of the embodiment; and

FIG. 5 is an explanatory diagram illustrating concepts of a current position, an available parking position, a desired parking position, a candidate parking area, and the like in the power supply service system according to the embodiment.

### DETAILED DESCRIPTION OF EMBODIMENTS

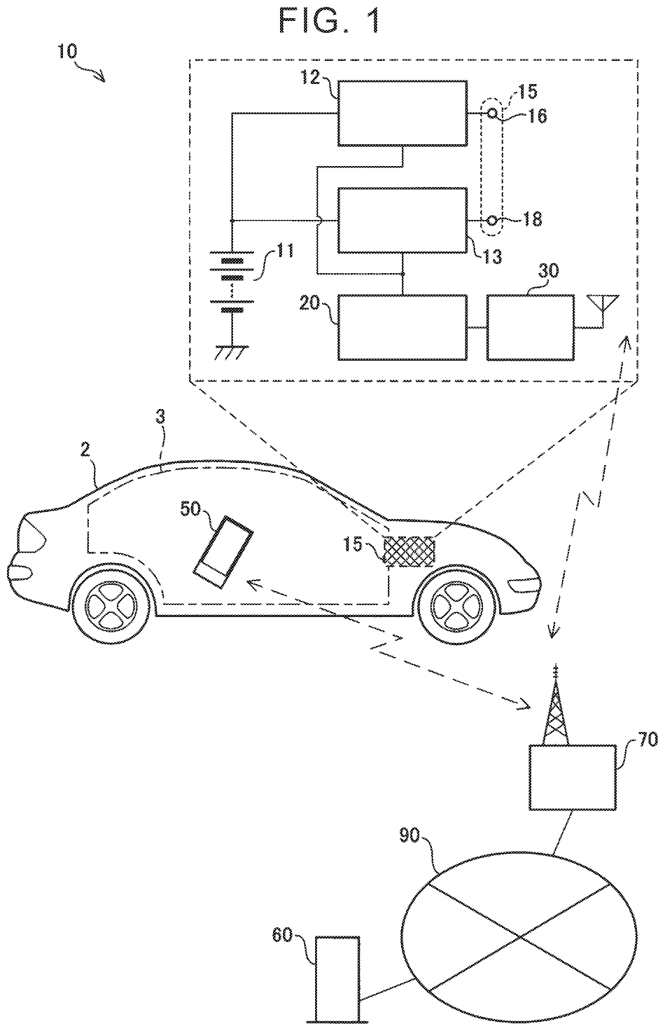

A power supply service system according to an embodiment will be described with reference to the drawings. Hereinafter, a power supply service system in which DC power or AC power can be supplied from a power supply port of a battery electric vehicle as a vehicle will be described as an example. FIG. 1 is an explanatory diagram illustrating a configuration example of a power supply service system according to the present embodiment. Battery electric vehicle also includes a hybrid electric vehicle provided for both the traveling motor and the engine (internal combustion engine). Vehicles also include non-fuel-engine (internal battery electric vehicle engine) types that do not include a running motor.

As shown in FIG. 1, the power supply service system 10 is capable of providing a service for supplying electric power to a user who utilizes a space in the vehicle cabin 3 by supplying DC power from the Universal Serial Bus (USB) port 16 provided in the vehicle cabin 3 of battery electric vehicle 2 or supplying AC power from AC port 18. The power supply service system 10 mainly includes a battery 11, a DC/DC converter 12, a DC/AC converter 13, a power supply controller 20, a navigation device 30, a smartphone 50, and a server computer 60.

The battery 11 is, for example, a storage battery capable of outputting a nominal voltage 12 V, and is mounted in an engine compartment or the like of a battery electric vehicle 2 as an auxiliary battery in the present embodiment. DC/DC converter 12 is capable of lowering the DC voltage output from the battery 11 to a predetermined voltage (e.g., 5 V) by a step-down converter and outputting the voltage to USB port 16. DC/AC converter 13 is capable of converting the DC voltage output from the battery 11 into a predetermined AC voltage (for example, 100 V) by a step-up converter and an inverter and outputting the converted voltage to AC port 18. In the present embodiment, these ports 16 and 18 are provided in the vehicle cabin 3 so as to be usable by the user as the power supply service port 15.

The power supply controller 20 is a control device including a microcomputer, a semiconductor memory such as a RAM, ROM or an EEPROM, an input/output interface, and the like. In the present embodiment, the power supply controller 20 output control commands for instructing DC/DC converters 12 and DC/AC converters 13 to start and end power supply. Therefore, a power supply control program capable of performing such a power supply control process is mounted on ROM or the like of the power supply controller 20.

The navigation device 30 is an in-vehicle route guidance device that can use a data communication service. In the present embodiment, the navigation device 30 includes a car navigation unit that provides a route guidance function for vehicles and a GPS module that can acquire present position data of a battery electric vehicle 2. In addition, a wireless data communication module capable of communicating with a base station 70 of a wireless data communication network for a mobile phone is provided.

The smartphone 50 is a portable information terminal device owned by a user of battery electric vehicle 2 and is capable of data communication with the base station 70. If wireless data communication with the base station 70 is possible, a notebook-type or tablet-type computer or the like may be used instead of the smartphone 50. The smartphone 50 also has a GPS modular that can acquire the present location information in which it exists (the present location information of battery electric vehicle 2 if the user who owns the smartphone 50 is on board battery electric vehicle 2).

In the present embodiment, at least one of the smartphone 50 and the navigation device 30 owned by the user is equipped with an application program for use registration (hereinafter referred to as “use registration application”) and an application program for map display (hereinafter referred to as “map display application”), which will be described later.

The server computer 60 is typically a computer having a database or the like, and is connected to the Internet 90 via an ISP (Internet Service Provider) or the like. In the present embodiment, for example, map information of the entire area of Japan, and information such as an available parking position, an unavailable parking position, and a candidate parking area that can be specified by latitude and longitude are stored in a database or the like. In the server computer 60, power supply availability control processing to be described later is performed, and therefore a power supply availability control program capable of executing the processing is mounted. Since the base station 70 is also connected to the Internet 90, the navigation device 30 mounted on battery electric vehicle 2 and the smartphone 50 owned by the user can perform data communication with the server computer 60.

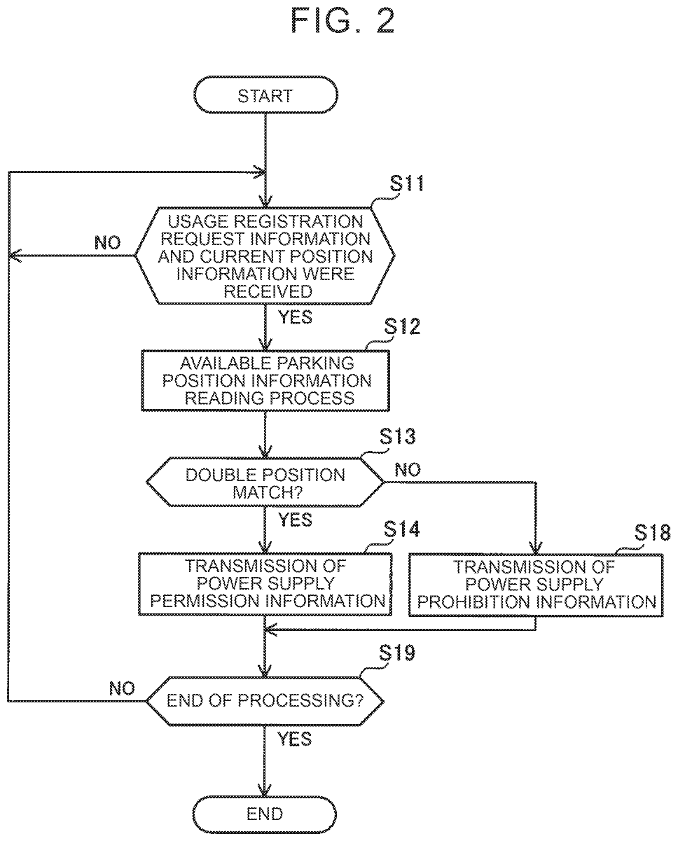

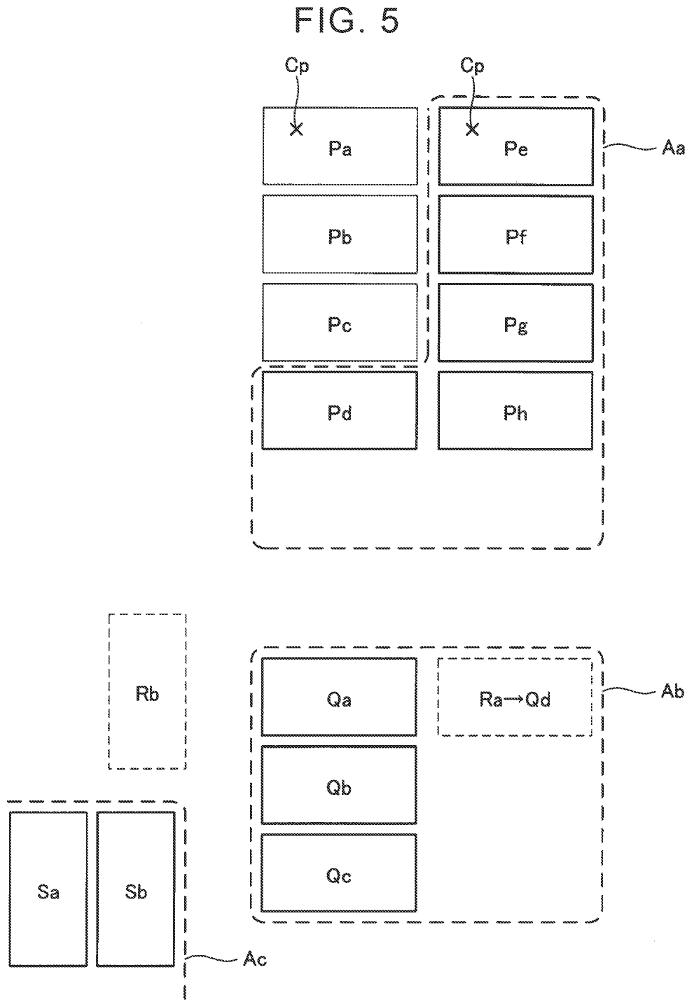

In the power supply service system 10 configured as described above, the server computer 60 or the like performs a plurality of power supply availability control processes as described below. FIG. 2 to FIG. 4 show a flowchart of power supply availability control processing executed by the server computer 60 of the power supply service system 10 according to the present embodiment. FIG. 5 is an explanatory diagram showing concepts of the current position Cp, the available parking positions Pd, Pe, Pf, Pg, Ph (hereinafter referred to as “available parking positions Pd-Ph”), the desired parking position Ra, the candidate parking areas Aa, Ab, Ac (hereinafter referred to as “candidate parking areas Aa-Ac”), and the like in the power supply service system 10 of the present embodiment. Here, a basic power supply availability control process will be described.

As illustrated in FIG. 2, in the basic-type power supply availability control process executed by the server computer 60, first, a process of determining whether or not the use-registration-request information and the present-position information have been received by S11 is performed. The use register request information is information for notifying the power supply service system 10 that a user of battery electric vehicle 2 wants to use a service for supplying power that can be supplied from USB port 16 or AC port 18. Further, the current position information is information indicating the current position of battery electric vehicle 2, and is obtained from GPS module of the navigation device 30 or the smartphone 50. These pieces of information are transmitted from the navigation device 30 or the like to the server computer 60 by executing a later-described use registration application by the navigation device 30 or the smartphone 50.

Therefore, when it is determined that the use registration-request information and the present position information have been received by S11 determination process (S11; YES), the process proceeds to the following S12, otherwise (S11; NO), the process of S11 is repeatedly performed until these pieces of information are received. In the following S12, a process of reading available parking position information from a database or the like of the server computer 60 is performed. For example, based on the current position information (latitude and longitude) received by S11, information of an available parking position closest to the position and information of an available parking position existing in a radial 50 m or less around the current position are read out.

In the following S13, the available parking position information read by S12 is compared with the present position information of battery electric vehicle 2 to determine whether both positions coincide with each other. The present position information is specified at the intersection of latitude and longitude, whereas the available parking position information is not a point but has a predetermined range (for example, a parking space for a normal passenger vehicle (a long-side 5.5 m, a rectangular range of a short-side 3 m), and the like). Therefore, when the current position exists within the predetermined range of the available parking position, it is determined that both positions coincide, and when the current position does not exist within the predetermined range, it is determined that both positions do not coincide.

If S13 determines that both positions coincide (S13; YES), battery electric vehicle 2 is likely to be in an available parking position. Therefore, S14 performs a process of transmitting the power supply permission data to the power supply controller 20 via the navigation device 30. If it is determined that both positions do not coincide (S13; NO), battery electric vehicle 2 is unlikely to be in an available parking position. Therefore, S18 performs a process of transmitting the power supply prohibition data to the power supply controller 20 via the navigation device 30.

Then, if S19 is inputting the process termination data (S19; YES), the present availability control process is terminated (END). When the information of the end of the process is not inputted (S19; NO), the process returns to S11, and a determination process of whether or not the use-registration-request information and the present-position information have been received is performed again. Then, S11 determination process is repeated until the use register request information or the like is transmitted from the smartphone 50 of the other user or the navigation device 30 of the other battery electric vehicle 2, and waits. Note that the information on the end of the processing is input from an input device such as a keyboard of the server computer 60, for example.

Although a flowchart is not shown in the usage registration application executed by the smartphone 50 or the navigation device 30 of the user, for example, the following information processing is performed. When the application is activated, an input determination process is performed to determine whether or not there is an input of the use registration. The input operation of the use registration is performed by, for example, displaying a software button “use registration” on a liquid crystal screen with a touch panel provided in the smartphone 50 or the navigation device 30 of the user, and the user touching the button. When it is determined by the input determination process that the use registration has been input, the present position information is acquired from the smartphone 50 of the user or GPS module included in the navigation device 30. The current position information is transmitted to the server computer 60 together with the use registration request information. Thereafter, the process returns to the input determination process. On the other hand, when it is not determined that there is an input of the use registration, the input determination process is repeated until there is an input, and the input of the use registration is awaited.

In addition, a software button of the “desired parking position” is also displayed on a liquid crystal screen with a touch panel provided in the navigation device 30 or the like. Therefore, when it is determined by the input determination process that the desired parking position has been input, the map display application included in the smartphone 50 or the navigation device 30 is activated to display a peripheral map centered on the current position on the liquid crystal screen. Then, the position information (desired parking position information) of the desired parking point designated by the user touching the touch panel is acquired, and the desired parking position information is transmitted to the server computer 60 together with the use registration request information, and the process returns to the input determination process. If it is not determined that the position information of the desired parking point has been input, the input determination process is repeated until there is an input to wait for the input of the use registration, but if the desired parking point is not designated even after a predetermined time has elapsed, the process returns to the process of displaying the “use registration” or “desired parking position”.

On the other hand, the power supply controller 20 performs the following power supply control processing (not shown). That is, when the power supply permission data transmitted from the server computer 60 is received, the power supply controller 20 transmits a control command for starting power supply to DC/DC converter 12 and DC/AC converter 13. In addition, when the power supply prohibition data is received, the power supply controller 20 transmits a control command for stopping the power supply to DC/DC converter 12 and DC/AC converter 13. DC/DC converter 12 (DC/AC converter 13) receives a control command to initiate power supply and supplies power to the device connected to USB port 16 (AC port 18). DC/DC converter 12 (DC/AC converter 13), which receives the control command for stopping the power supply, does not provide power even if the device is connected to USB port 16 (AC port 18). As a result, as shown in FIG. 5, when the current position Cp of battery electric vehicle 2 and any one of the available parking positions Pd-Ph, Qa, Qb, Qc, Sa, Sb coincides with each other (the current position Cp and the available parking position Pe coincide with each other in the drawing), the user of battery electric vehicle 2 can be serviced by supplying power from USB port 16 or AC port 18. In addition, when the current position Cp and the available parking positions Pd-Ph, Qa, Qb, Qc, Sa, Sb do not coincide with each other (when the current position Cp and the unavailable parking position Pa coincide with each other in the drawing), the user of battery electric vehicle 2 cannot be serviced to provide such power.

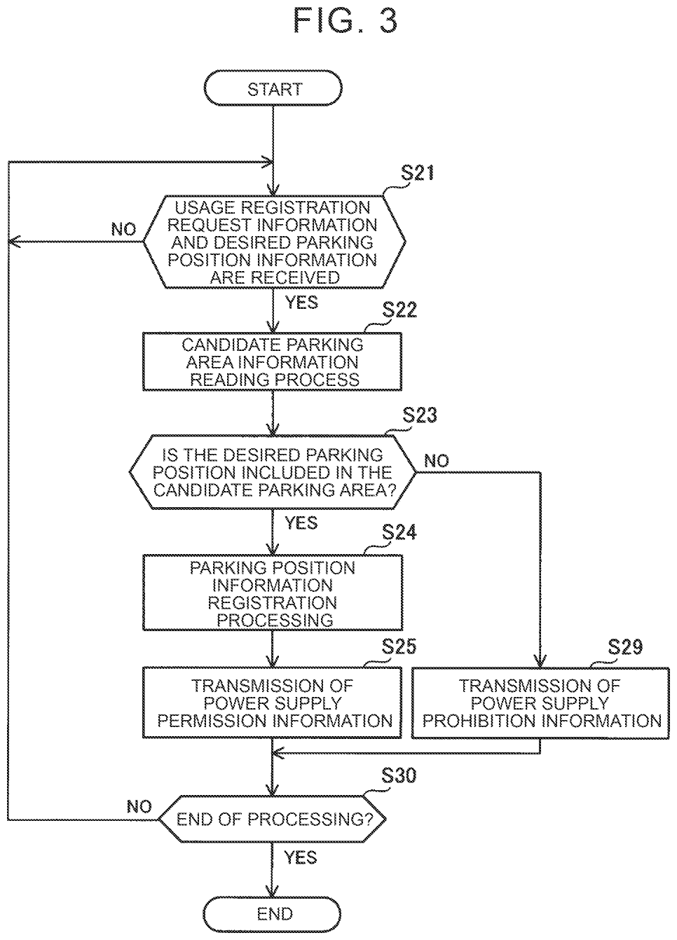

Next, the power supply availability control process of the candidate position addition type executed by the server computer 60 will be described with reference to FIG. 3. The power supply availability control process is performed by the server computer 60 in response to the user transmitting the desired parking position information in place of the present position information of battery electric vehicle 2, so that the desired parking position information can be added as the candidate parking position information.

As illustrated in FIG. 3, in the power supply availability control process of the candidate-position addition type, first, a process of determining whether or not the use-registration-request information and the desired parking position information have been received by S21 is performed. The use registration request information is the same as in the power supply availability control process described with reference to FIG. 2. The desired parking position information is position information that is not yet stored as an available parking position in a database or the like of the server computer 60. In the present embodiment, the user designates the map display application executed by the smartphone 50 or the navigation device 30 of the user, and the map display application is transmitted from the navigation device 30 or the like to the server computer 60.

When it is determined by S21 determination process that the use-registration-request information and the desired parking position information have been received (S21; YES), the process proceeds to the following S22. When it is determined that the use-registration-request information and the desired parking position information have not been received by S21 determination process (S21; NO), S21 process is repeated until these pieces of information are received. In S22, a process of reading out the information of the candidate parking area from the database or the like of the server computer 60 is performed. For example, based on the desired parking position information (latitude and longitude) received by S21, information of a parking candidate area closest to the position and information of a candidate parking area existing within a radial 50 m around the desired position are read out.

In the following S23, a process of determining whether or not a desired parking position is included in the candidate parking area read by S22 is performed. For example, as illustrated in FIG. 5, the desired parking position Ra can be registered as an available parking position when the desired parking position Ra is included in the nearest candidate parking area Ab among the three candidate parking areas Aa-Ac existing in the vicinity of the desired parking position Ra (S23; YES). Therefore, in S24, a process of registering, i.e., storing, the desired parking position as an available parking position in a database or the like of the server computer 60 is performed. In this embodiment, the desired parking position Ra is registered as an available parking position Qd. Then, S25 transmits the power supply permission data to the power supply controller 20.

On the other hand, for example, as illustrated in FIG. 5, when the desired parking position Rb is not included in any candidate parking areas Aa-Ac in the vicinity thereof (S23; NO), the desired parking position Ra cannot be registered as an available parking position. Therefore, S29 transmits the power supply prohibition data to the power supply controller 20 via the navigation device 30. Note that the process termination determination process performed after the transmitting process (S25, S29) is the same as S19 of the power supply availability control process described with reference to FIG. 2, and thus the explanation thereof is omitted.

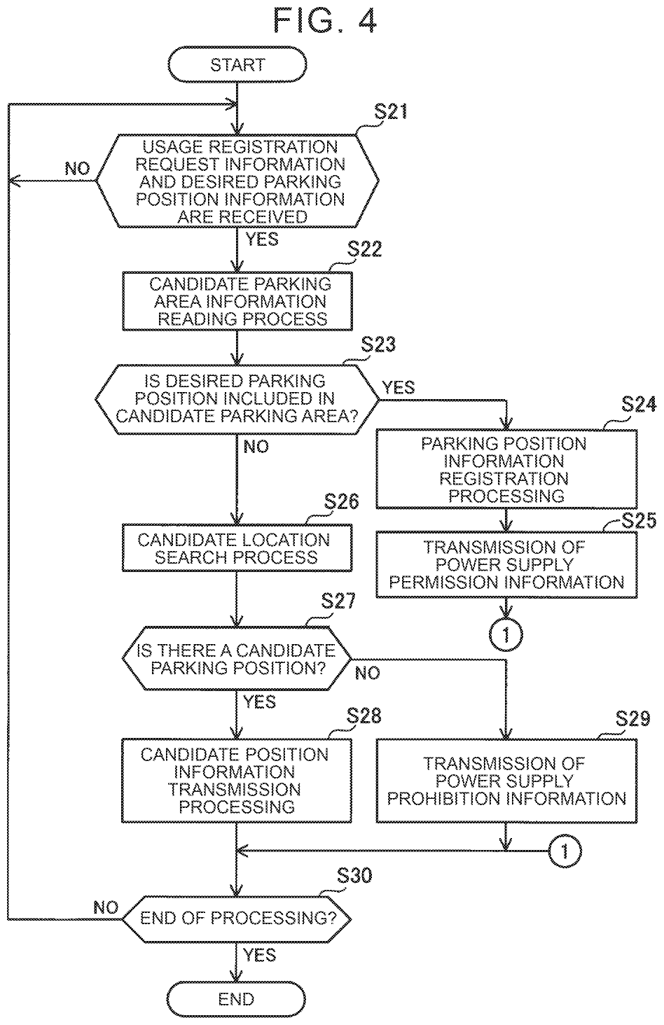

Next, the power supply availability control process of the candidate position proposal type executed by the server computer 60 will be described with reference to FIG. 4. In the candidate position addition type described with reference to FIG. 3, when the desired parking position designated by the user is not included in the candidate parking area existing in the vicinity thereof or the like, the server computer 60 performs a process of proposing another available parking position.

For example, as illustrated in FIG. 5, when the desired parking position Rb designated by the user is not included in any candidate parking areas Aa-Ac in the vicinity thereof (S23; NO), the respective processes of S26, S27, S28 illustrated in FIG. 4 are performed. Thus, the server computer 60 searches for a candidate parking position that may exist within a predetermined range from the desired parking position information (for example, within a radial 50 m about the desired parking position) (S26), and when such a candidate parking position exists (S27; YES), the candidate parking position information is transmitted to the smartphone 50 or the navigation device 30 of the user (S28). In the embodiment illustrated in FIG. 5, since a plurality of desired parking position Rb and the like exist around the available parking positions Qa-Qc, Pc, Pd, Pg, Ph, Sa, Sb, the available parking position Sb closest to the desired parking position Rb is selected as the candidate parking position and transmitted from among them. When there is no available parking position around the desired parking position (S27; NO), the power supply prohibition data is transmitted to the power supply controller 20 (S29).

As described above, in the power supply service system 10 of the present embodiment, the power supply controller 20 and the navigation device 30 (hereinafter referred to as “power supply controller 20 and the like”) control whether or not power is supplied from the battery 11 to USB port 16 and AC port 18, and transmit the current position

Cp of battery electric vehicle 2 to the outside of the vehicle. The server computer 60 is capable of communicating with the power supply controller 20 and the like, and stores battery electric vehicle 2 available parking positions Pd-Ph. When the current position Cp and any one of the available parking positions Pd-Ph, Qa-Qc, Sa, Sb (hereinafter referred to as “available parking position Pd or the like”) received from the power supply controller 20 or the like matches, the server computer 60 transmits power supply permission information allowing power to be supplied to the power supply controller 20 or the like. In addition, in a case where they do not match, the power supply prohibition information for prohibiting the supply of electric power is transmitted to the power supply controller 20 or the like.

Accordingly, in order to receive electric power from USB port 16 and AC port 18, battery electric vehicle 2 must be parked at a predetermined available parking position Pd or the like. When the current position Cp and the unavailable parking positions Pa-Pc that are places in which parking is impossible coincide with each other (when the current position Cp does not coincide with any of the available parking position Pd and the like), the power cannot be supplied from USB port 16 or AC port 18, so that it is difficult to park battery electric vehicle 2 in such a place. Therefore, it is possible to suppress the occurrence of inconvenience caused by the parking place. Further, since the power supply is not received even when battery electric vehicle 2 moves from the available parking position Pd or the like, the power supply is not received even in battery electric vehicle 2 while the vehicle is traveling. Therefore, the moving battery electric vehicle 2 can be prompted to concentrate on driving.

Further, for example, the smartphone 50 and the navigation device 30 operated by the user of battery electric vehicle 2 can communicate with the server computer 60 and transmit the desired parking position Ra of battery electric vehicle 2. The server computer 60 also stores candidate parking areas Aa-Ac that can be parked by battery electric vehicle 2. When the desired parking position Ra received from the smartphone 50 is included in any candidate parking areas Aa-Ac in the candidate parking area Ab, the server computer 60 stores the desired parking position Ra as available parking position Qd. As a result, the server computer 60 adds the desired parking position Ra transmitted from the smartphone 50 as available parking position Qd in addition to the previously stored available parking position Pd and the like. Therefore, power is supplied from USB port 16 and AC port 18 even when battery electric vehicle 2 is parked in the available parking position Qd which is the desired parking position Ra. Therefore, the available parking position Pd and the like can be increased according to the needs of the user.

When the desired parking position Rb received from the smartphone 50 is not included in the candidate parking areas Aa-Ac, the server computer 60 selects the available parking position Sb closest to the desired parking position Rb from the candidate parking areas Aa-Ac as the candidate parking position, and transmits the candidate parking position (available parking position Sb) to the smartphone 50. As a result, for example, the user of battery electric vehicle 2 who operates the smartphone 50 can know the nearest candidate parking position (available parking position Sb) in the desired parking position Ra transmitted earlier, so that it is not necessary to search for the nearby available parking position Pd or the like stored in the server computer 60. Therefore, the convenience of the user in such a power supply service can be improved.

In the above-described embodiment, the power supply controller 20 that has received the power supply permission information and the power supply prohibition information by the server computer 60 transmits the power supply permission information and the power supply prohibition information outputs a control command for starting or ending the control to DC/DC converter 12 and DC/AC converter 13. The server computer 60 constituting the power supply service system 10 of the present embodiment is not limited to this, and may transmit the power supply prohibition information to the power supply controller 20 or the like, for example, after a predetermined time (for example, 2 hours) has elapsed since the power supply permission information was transmitted. Accordingly, when a predetermined time has elapsed since the power supply from USB port 16 or AC port 18 of battery electric vehicle 2 is started, the power supply is stopped, and thus the power supply service can be suppressed from being used indefinitely in time. Further, it is possible to provide the power supply service as a time-based service.

Considerations regarding the embodiment technology will be described. Battery electric vehicle 2 corresponds to an exemplary vehicle. The battery 11 corresponds to an example of a power supply. USB port 16 and AC port 18 correspond to exemplary power supplying ports. The power delivery port is not limited to a USB port. In addition, USB port 16 may be configured to transmit various types of information together with power. The power supply controller 20 and the navigation device 30 correspond to an example of an in-vehicle computer. Note that the function of the navigation device 30 may be included in the smartphone 50. The smartphone 50 corresponds to an example of an information terminal device. The server computer 60 corresponds to an example of an outside computer.

The available parking position Sb corresponds to an exemplary candidate parking position that is closest to the desired parking position Rb.

While specific examples of the present disclosure have been described in detail above, these are merely illustrative and do not limit the scope of the claims. Various modifications and variations of the specific examples described above are included in the technology described in the claims. In addition, the technical elements described in this specification or in the drawings exhibit technical usefulness alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A power supply service system that uses a power supply port included in a vehicle, the power supply service system comprising:
a power supply mounted on the vehicle;
an in-vehicle computer that controls whether to supply power from the power supply to the power supply port, and transmits a current position of the vehicle to an outside of the vehicle; and
an outside computer that is able to communicate information with the in-vehicle computer, and stores an available parking position of the vehicle, wherein the outside computer transmits power supply permission information for allowing supply of the power to the in-vehicle computer when the current position coincides with the available parking position, and transmits power supply prohibition information for prohibiting supply of the power to the in-vehicle computer when the current position received from the in-vehicle computer does not coincide with the available parking position.

2. The power supply service system according to claim 1, further comprising an information terminal device that is able to communicate information with the outside computer and transmits a desired parking position of the vehicle, wherein the outside computer stores also a candidate parking area in which parking of the vehicle is available, and when the desired parking position received from the information terminal device is included in the candidate parking area, stores the desired parking position as the available parking position.

3. The power supply service system according to claim 2, wherein when the desired parking position received from the information terminal device is not included in the candidate parking area, the outside computer selects a candidate parking position closest to the desired parking position from within the candidate parking area, and transmits the selected candidate parking position to the information terminal device.

4. The power supply service system according to claim 1, wherein the outside computer transmits the power supply prohibition information to the in-vehicle computer after a predetermined time has elapsed since transmission of the power supply permission information.
